(19) United States
(12) Patent Application Publication
(10) Pub. No.: US 2018/0240187 A1
(43) Pub. Date: Aug. 23, 2018

(54) System and Method for Matching Lender with Borrower based on Color-Coded Financial Ratios and through an Online Meeting

(71) Applicant: The Loan Desk, Inc., Fullerton, CA (US)

(72) Inventors: Nelson Lee, Fullerton, CA (US); Boltran Hu, Torrance, CA (US)

(21) Appl. No.: 15/436,621

(22) Filed: Feb. 17, 2017

(51) Int. Cl. G06Q 40/02; G06Q 10/10

(52) U.S. Cl. CPC G06Q 40/025; G06Q 10/1095

(57) ABSTRACT

A system and method for matching a lender and a borrower based on color-coded financial ratios, and discussing the loan through an online meeting between the borrower and lender. The method creates an efficient environment for matching a borrower, such as a consumer, with at least one lender, such as a bank. The borrower and at least one lender interact on a network. The borrower submits loan related data to a database and algorithm for analyzing to generate a color-coded financial ratio that provides the lender with efficient tools to determine whether the potential borrower qualifies for the respective lending criteria. A chatbot answers queries from the borrower or lender. An interactive calendar allows the borrower and lender to corroborate on a meeting date and time, and an Internet operable image capturing device, such as webcam, allows for an online meeting between borrower and lender to discuss the loan.

### FIELD OF THE INVENTION

The present invention relates generally to a system and method for matching a lender and a borrower based on color-coded “uniformed commercial code” financial ratios, and discussing the loan through an online meeting between the borrower and lender. More so, the present invention relates to a system and method that provides a network that enables at least one lender and a borrower to interact, so as to potentially consummate a loan; whereby the borrower submits loan related data in a plurality of formats “pdf, excel, jpeg” onto the network; and whereby the loan related data is analyzed by an algorithm to generate color-coded “green (good), yellow (ok), red (bad)” financial ratios of the borrower and reviewed by the at least one lender to determine the borrower's eligibility for the loan; and whereby a potential meeting between the borrower and the lender is set up though an interactive calendar on the network; and whereby the borrower and the lender discuss the conditions of the loan through an online meeting on the network, including an online assistance that enables interaction with a chatbot; whereby the chatbot facilitates interaction during the steps of the method, and negating the need for human interaction as a cost saving tool.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often, consumers require financing large and expensive purchases for a variety of products or services. Consumer loans origination is the process by which a consumer (borrower) applies for a new loan and a lender processes the consumer's application. Usually, loan origination is a lengthy process because the consumer's loan application is manually processed by the lender wherein the lender reviews the application to determine whether the consumer qualifies for the loan by meeting various credit-worthiness criteria. Manual processing of an application is unsatisfactorily time-consuming. For the lender, time-consuming application review is expensive and sometimes involves reviews of obviously unworthy borrowers' applications.

When the lender is a bank or financial institution, borrowers tend to research the available options as advertised and match themselves with the lender they feel will offer them the lowest interest rate, or the best overall package after other factors are considered. This system of matching may be considered undesirable by borrowers since it is time consuming and may be considered complicated. Therefore automatic systems, accessible over a computer network, have been developed to match a borrower to the lender that offers the lowest interest rate.

For the consumer, time-consuming application review is not practical for point-of-sale purchases. Manual processing of a loan application can also be problematic because the consumer must apply to multiple lenders at once so that (a) multiple loans may be compared and (b) the costs of determining credit-worthiness can be high (e.g., requesting multiple credit reports can generate excess lender fees and/or have a negative impact on a consumer's credit worthiness). In many instances, the borrower complains that the loan process is time consuming, frustrating and they didn't know how banks evaluated their financials loan request.

Other proposals have involved matching lenders with borrowers. The problem with these methods is that they do not allow the borrower to submit data in multiple formats, or provide easy to read color-coded financial reports. These prior art methods also require a physical meeting between borrower and lender, which is time consuming. Even though the above cited gripping loan matching methods meets some of the needs of the market, a system and method for matching a lender and a borrower based on color-coded financial ratios, and discussing the loan through an online meeting between the borrower and lender is still desired.

### SUMMARY

Illustrative embodiments of the disclosure are generally directed to a system and method for matching a lender and a borrower based on color-coded financial ratios, and discussing the loan through an online meeting between the borrower and lender.

The system and method creates an efficient environment for matching a borrower, such as a consumer, with at least one lender, such as a bank. The system and method is operable on a network, such as a website, that is accessible by both the lender and the borrower. The network enables at least one lender and a borrower to interact, so as to potentially consummate a loan. The borrower submits a loan related data in a plurality of formats onto the network. The system and method provides a database for storing a population of loan related data from both the lender and borrower.

The loan related data is analyzed by an algorithm to generate color-coded financial ratios of the borrower and the loan related data, and reviewed by the at least one lender to determine the borrower's eligibility for the loan. The algorithm may also generate logical and pertinent answers to queries posed by the borrower or lender on the website by learning past queries from previous borrowers and lenders.

In some embodiments, a chatbot may also be used to help answer queries by the borrower. The answers from the borrower are queried from the loan related data that is input into the database. If the borrower does not meet the lender's requirements, or of the borrower is not satisfied with the conditions of the loans from the lender, the algorithm is configured to recommend a different potential lender for the borrower.

A potential meeting between the borrower and the lender is set up though an interactive calendar on the network. The borrower and the lender discuss the conditions of the loan through an online meeting on the network. A chatbot may also be used to help answer queries by the borrower or the at least one lender. The answers may be learned or may be derived from the loan related data that is input into the database.

In one aspect, a method for matching a lender and a borrower based on color-coded financial ratios, and discussing the loan through an online meeting, comprises:
providing a network accessible by at least one lender and a borrower, whereby the at least one lender and the borrower interact on the network;
submitting, by the borrower, a loan related data onto the network, the loan related data configured into at least one format;
processing the loan related data with an algorithm;
answering, through analysis by the algorithm, at least one query from the borrower, or the at least one lender, or both;
generating, through analysis by the algorithm, a color-coded financial ratio based on the loan related data;
initially approving the borrower by the at least one lender based on the color-coded financial ratio;
accepting, by the borrower, the potential lender;
setting up an online meeting, through an interactive calendar, between the at least one lender and the initially approved borrower; and
performing the online meeting with an Internet operable image capturing device between the at least one lender and the initially approved borrower.

In another aspect, the network includes at least one of the following: a website, an Internet, an Intranet, and a social media site.

In another aspect, the at least one lender includes at least one of the following: a bank, and a lending agent.

In yet another aspect, the borrower includes at least one of the following: a consumer, a corporation, and a government.

In yet another aspect, the loan related data includes at least one of the following: name, personal information, job information, contact information, social security number, bank account, financial information, EIN#, business plan, and the purpose for the loan request.

In yet another aspect, the algorithm includes at least one of the following: a matching algorithm, a financial ratio algorithm, a query, and a chat bot algorithm.

In yet another aspect, the matching algorithm is configured to match and rank data points from the loan related data, the matching algorithm is also configured to weigh averages and generate graphs from the data points.

In yet another aspect, the algorithm is configured to learn.

In yet another aspect, the method further comprises a step of storing the loan related data in a database.

In yet another aspect, the method further comprises a step of retrieving, by the algorithm or the at least one lender, the loan related data from the database.

In yet another aspect, the color-coded financial ratio comprises multiple loan industry standard metrics categorized into multiple colors.

In yet another aspect, the interactive calendar is viewable and manipulated by both the at least one lender and the borrower.

In yet another aspect, the online meeting is operable through an Internet operable image capturing device.

In yet another aspect, the step of answering, through analysis by the algorithm, at least one question from the borrower, or the lender, or both further comprises a chatbot configured to interact with the borrower.

In yet another aspect, the chatbot includes at least one of the following: a talkbot, a Bot, a chatterbox, an artificial conversational entity, and a computer program which conducts a conversation via auditory or textual methods.

One objective of the present invention is to efficiently match a borrower with at least one lender for a loan.

Another objective is to provide a loan matching system and method that streamlines the loan process.

Another objective is to provide a network that is easily accessible by both borrower and lender.

Another objective is to enable the borrower to submit loan related data in different formats.

Another objective is to provide an algorithm that answers queries from the borrower, or the lender, or both.

Another objective is to analyze the loan related date, so as to generate a color-coded financial ratio for review by the lender.

Another objective is to facilitate the meeting through an interactive calendar that coordinates availability of the lender and the borrower.

Another objective is to provide an Internet operable image capturing device meeting between the lender and the borrower, so as to save time and travel.

Another objective is to reduce the loan process from one month to two weeks.

Another objective is to provide an easy to operate loan matching system and method for both the borrower and the lender.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for matching a lender and a borrower based on color-coded financial ratios, and discussing the loan through an online meeting, in accordance with an embodiment of the present invention;

FIG. 2 illustrates a flowchart of an exemplary method for matching a lender and a borrower based on color-coded financial ratios, and discussing the loan through an online meeting, in accordance with an embodiment of the present invention;

FIG. 3 illustrates a flowchart of an alternative method for matching a lender and a borrower from the view of a lender dashboard, in accordance with an embodiment of the present invention; and

FIG. 4 illustrates a flowchart of an alternative method for matching a lender and a borrower and application of data points to generate a color-coded financial ratio, in accordance with an embodiment of the present invention.

Like reference numerals refer to like parts throughout the various views of the drawings.

### DETAILED DESCRIPTION OF THE INVENTION

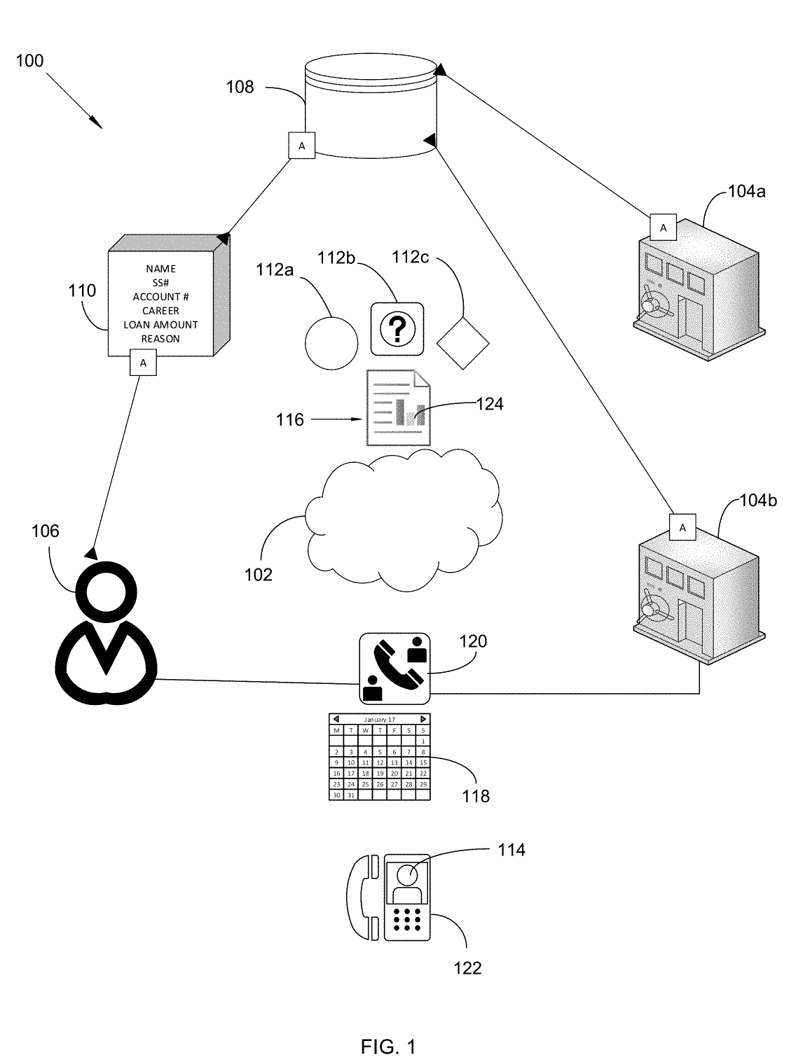

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 100 and method 200 for matching a lender 104a, 104b and a borrower 106 based on a color-coded financial ratio 116, and discussing the loan through an online meeting 120 between the borrower 106 and lender 104a, 104b is referenced in FIGS. 1-4. The system 100 and method 200 creates an efficient environment for matching a borrower 106, such as a consumer, with at least one lender 104a, 104b, such as a bank. The communication between the borrower 106 and lender 104a, 104b is streamlined, so that time is saved and standard loan processing steps are reduced. Also, the system 100 and method 200 create a more transparent environment for helping the borrower 106 to understand the lending requirements of the at least one lender 104a, 104b.

Further, through use of a color-coded financial ratio 116, the lender 104a, 104b has better tools to perform due diligence in determining the eligibility of the borrower 106 for the loan. And in an additional aspect of streamlining the lending process, an interactive calendar 118 allows the borrower 106 and lender 104a, 104b to corroborate on a meeting date and time. This allows for more convenience for both parties. An Internet operable image capturing device 122, such as a webcam, allows for an online meeting 120 between borrower 106 and lender 104a, 104b. This remote interviewing capacity negates the need for time consuming physical interactions in a brick-and-mortar building.

As referenced in FIG. 1, the system 100 is operable on a network 102 that is accessible by both the lender 104a, 104b and the borrower 106. The network 102 enables at least one lender 104a, 104b and a borrower 106 to interact, so as to potentially consummate a loan. The possibility of having more than one lender available also benefits the borrower, as competition is increased.

In some embodiments, the network 102 may include, without limitation, a website, an Internet, an Intranet, and a social media site. The network 102 may require registration and a password from the lender 104a, 104bs and borrower 106 to participate therein. In one embodiment, both the borrower 106 and the lender 104a may access the network 102 through a dashboard or splash page, known in the art for interacting on a website.

In another embodiment, the borrower 106 or lender 104a, 104b may be required to agree to conditions before being accepted into the network 102. The system 100 may require a background check to be employed on the borrower 106, the lender 104a, 104b, or both. In one alternative embodiment, a fee may be required from the borrower 106 or the lender 104a, 104b to join the network 102. The borrower 106 may include, without limitation, a consumer, a corporation, and a government. The lender 104a, 104b may include, without limitation, a bank, a lending agent, a private lender, and crowd sourcing.

The system 100 allows the borrower 106 to easily submit a loan related data 110 into the network 102 for consideration by at least one lender 104a, 104b. The loan related data 110 may include, without limitation, a name, personal information, job information, contact information, social security number, bank account, financial information, EIN#, business plan, and the purpose for the loan request.

In one embodiment, the loan related data 110 may be submitted in a plurality of formats onto the network 102. This creates great flexibility for the borrower to submit data 110 for the loan determination process. In some embodiments, the formats may include a spreadsheet, a word document, PDF, picture, a note pad, a file, a ledger, a presentation, and a video recording. The system 100 enables the network 102 to receive all forms of media and formatting for viewing by the at least one lender 104a, 104b. In one alternative embodiment, an artificial intelligence systems would allow a borrower 106, such as a business to submit a video of their business without the loan related data 110 or other financial information.

In some embodiments, the system 100 provides a database 108 for storing a population of loan related data 110 from both the lender 104a, 104b and borrower 106. The system 100 and method 200 provides a database 108 for storing a population of loan related data 110 from both the lender 104a, 104b and borrower 106. The database 108 may include, without limitation, a server, a cloud, a data storage device, a memory storage device, and an external drive.

In one embodiment of the possible data in the database 108, the lender 104a, 104b provides loan requirements, loan types available, and borrower 106 preferences into the database 108. The borrower 106 provides personal information, financial information, EIN#, business plan, and the purpose of the loan into the database 108. The loan related data 110 may be retrieved from the database 108 by an algorithm 112a, 112b, 112c for analyzing data points 124 therein, or by the lender 104a, 104b for assessing the borrower 106 for a loan.

The loan related data 110 is analyzed by an algorithm 112a, 112b, 112c that generates financial data, matches appropriate borrowers with the at least one lender 104a, 104b, and has intelligence to learn historical queries, so as to answer queries from the borrower 106 or the at least one lender 104a, 104b. In some embodiments, the algorithm may include a matching algorithm 112a, a financial algorithm 112c, and a query algorithm 112b.

The financial algorithm 112c is configured to process the financial information in the loan related data 110 and generate at least one color-coded financial ratio 116 based on the loan related data 110. The color-coded financial ratio 116 may comprise of multiple loan industry standard metrics that are categorized into multiple colors. For example, a green color signifies a potentially reliable borrower 106; a yellow color signifies a historically mediocre borrower 106; and a red color signifies a borrower 106 with past repayment or financial issues.

The matching algorithm 112a is configured to match and rank data points 124 from the loan related data 110. The matching algorithm 112a may match lender 104a, 104bs from a pool of borrowers, and vice versa. The financial algorithm 112c is configured to weigh averages and generate graphs from the data points 124. For example, a credit score may receive a score and be color-coded; and further, a prior bankruptcy may deduct from the score, resulting in a different color-code.

The generated color-coded financial ratio 116 is reviewed by the at least one lender 104a, 104b to determine the borrower's 106 eligibility for the loan. In this manner, the color-coded financial ratio 116 can provide a snapshot of the borrower 106 to help the lender 104a, 104b determine eligibility for the loan, and also to help the lender 104a, 104b more efficiently analyze the borrower 106 and financial and personal history of the borrower 106.

The query algorithm 112b may also generate logical and pertinent answers to queries posed by the borrower 106 or lender 104a, 104b on the website by learning past queries from previous borrowers 106 and lenders 104a, 104b. The query algorithm 112b is configured to learn patterns of prior queries, answers, and frequently asked questions, so as to efficiently answer queries by the borrower 106 or lender 104a, 104b.

In some embodiments, the answers that are returned to the borrower 106 are queried from the loan related data 110 that is input into the database 108. If the borrower 106 does not meet the lender's 104a, 104b requirements, or of the borrower 106 is not satisfied with the conditions of the loans from the lender 104a, 104b, the algorithm 112a-c is configured to recommend a different potential lender 104a, 104b for the borrower 106.

In one embodiment, a chatbot 114 may be used to interact with, answer the queries from the borrower 106 or lender 104a, 104b. The chatbot 114 is especially effective in helping to answer queries from the borrower 106, or the at least one lender 104a, 104b, or both. The answers are derived through machine intelligence learned means known in the art, or from the loan related data 110 that is input into the database 108.

In some embodiments, the chatbot 114 may include, without limitation, a talkbot, a bot, a chatterbox, an artificial conversational entity, and a computer program which conducts a conversation via auditory or textual method 200s. Though in other embodiments, a live person may be used for interaction and answering questions.

After the lender 104a, 104b has performed an initial approval of the borrower 106, and the borrower 106 approves of the potential lender 104a, 104b, an online meeting 120, or interview, between the borrower 106 and the lender 104a, 104b may be set up. The time and date for the online meeting 120 is arranged through an interactive calendar 118 that is accessible on the network 102.

The interactive calendar 118 may include a calendar 118 known in the art through which the borrower 106 and lender 104a, 104b can mark possible times and dates to meet each other, so as to further discuss the loan. The interactive calendar 118 is viewable and manipulated by both the at least one lender 104a, 104b and the borrower 106. The times and dates may be altered by either party, and the other party notified in a timely manner.

In some embodiments, the borrower 106 and the lender 104a, 104b discuss the conditions of the loan through an online meeting 120 on the network 102. The online meeting 120 may occur on the network 102, and occur between the at least one lender 104a, 104b and the initially approved borrower 106. The online meeting 120 occurs at the time and date set up through the interactive calendar 118.

The borrower 106 and the lender 104a, 104b may communicate remotely through an Internet operable image capturing device 122, which may include a webcam or any remote conference software known in the art. Furthermore, the borrower 106 and the lender 104a, 104b may review and sign documents through while on the online meeting 120.

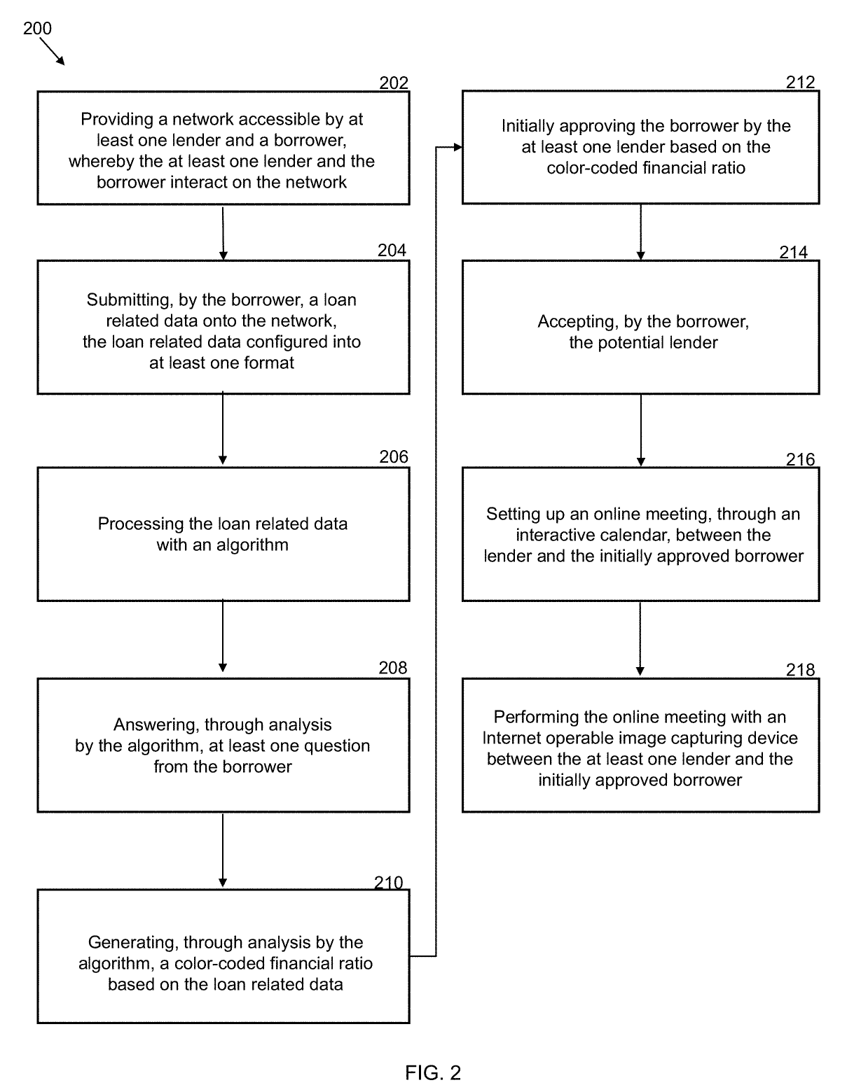

FIG. 2 illustrates a flowchart of an exemplary method 200 for matching a lender and a borrower based on color-coded financial ratios, and discussing the loan through an online meeting. In one embodiment, an initial Step 202 may include providing a network 102 accessible by at least one lender 104a, 104b and a borrower 106, whereby the at least one lender 104a, 104b and the borrower 106 interact on the network 102.

The method 200 may further comprise a Step 204 of submitting, by the borrower 106, a loan related data 110 onto the network 102, the loan related data 110 configured into at least one format. In one embodiment, the loan related data 110 may be submitted in a plurality of formats onto the network 102. This creates great flexibility for the borrower to submit data 110 for the loan determination process.

A Step 206 includes processing the loan related data 110 with an algorithm 112a, 112b, 112c. The loan related data 110 is analyzed by an algorithm 112a, 112b, 112c that generates financial data, matches appropriate borrowers with the at least one lender 104a, 104b, and has intelligence to learn historical queries, so as to answer queries from the borrower 106 or the at least one lender 104a, 104b. In some embodiments, the algorithm may include a matching algorithm 112a, a financial algorithm 112b and a query algorithm 112c.

In some embodiments, a Step 208 comprises answering, through analysis by the algorithm, at least one question from the borrower 106. In one embodiment, a chatbot 114 may be used to interact with, answer the queries from the borrower 106 or lender 104a, 104b. The chatbot 114 is especially effective in helping to answer queries from the borrower 106, or the at least one lender 104a, 104b, or both. The answers are derived through machine intelligence learned means known in the art, or from the loan related data 110 that is input into the database 108.

A Step 210 includes generating, through analysis by the algorithm 112c, a color-coded financial ratio 116 based on the loan related data 110. The generated color-coded financial ratio 116 is reviewed by the at least one lender 104a, 104b to determine the borrower's 106 eligibility for the loan. In this manner, the color-coded financial ratio 116 can provide a snapshot of the borrower 106 to help the lender 104a, 104b determine eligibility for the loan, and also to help the lender 104a, 104b more efficiently analyze the borrower 106 and financial and personal history of the borrower 106.

In some embodiments, a Step 212 may include initially approving the borrower 106 by the at least one lender 104a, 104b based on the color-coded financial ratio 116. A Step 214 comprises accepting, by the borrower 106, the potential lender 104a, 104b. A Step 216 may include setting up an online meeting 120, through an interactive calendar 118, between the at least one lender 104a, 104b and the initially approved borrower 106. A final Step 218 comprises performing the online meeting 120 with an Internet operable image capturing device 122 between the at least one lender 104a, 104b and the initially approved borrower 106. The borrower 106 and the lender 104a, 104b may communicate remotely through an Internet operable image capturing device 122, which may include a webcam or any remote conference software known in the art.

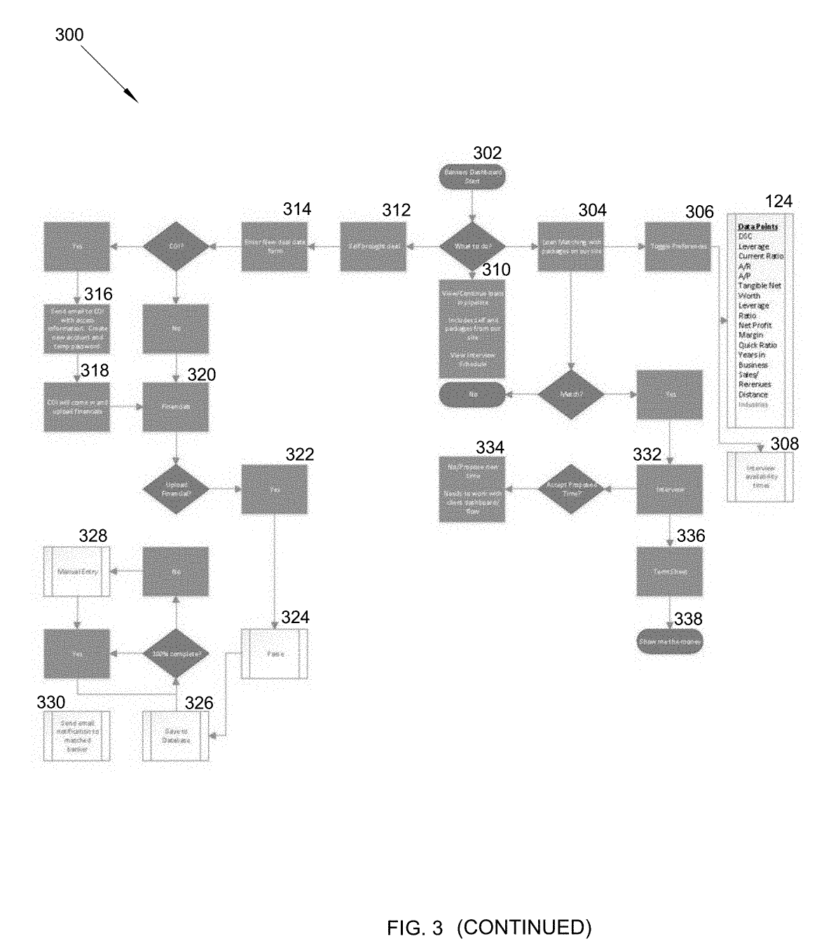

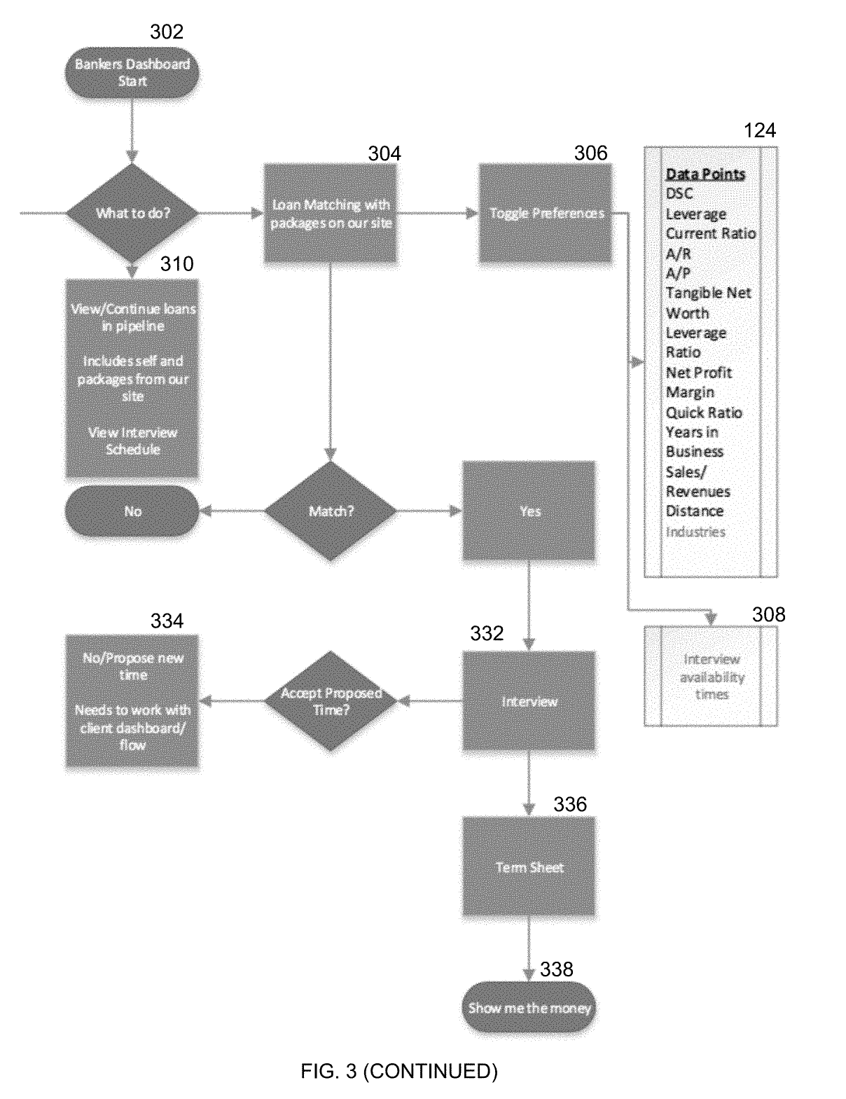

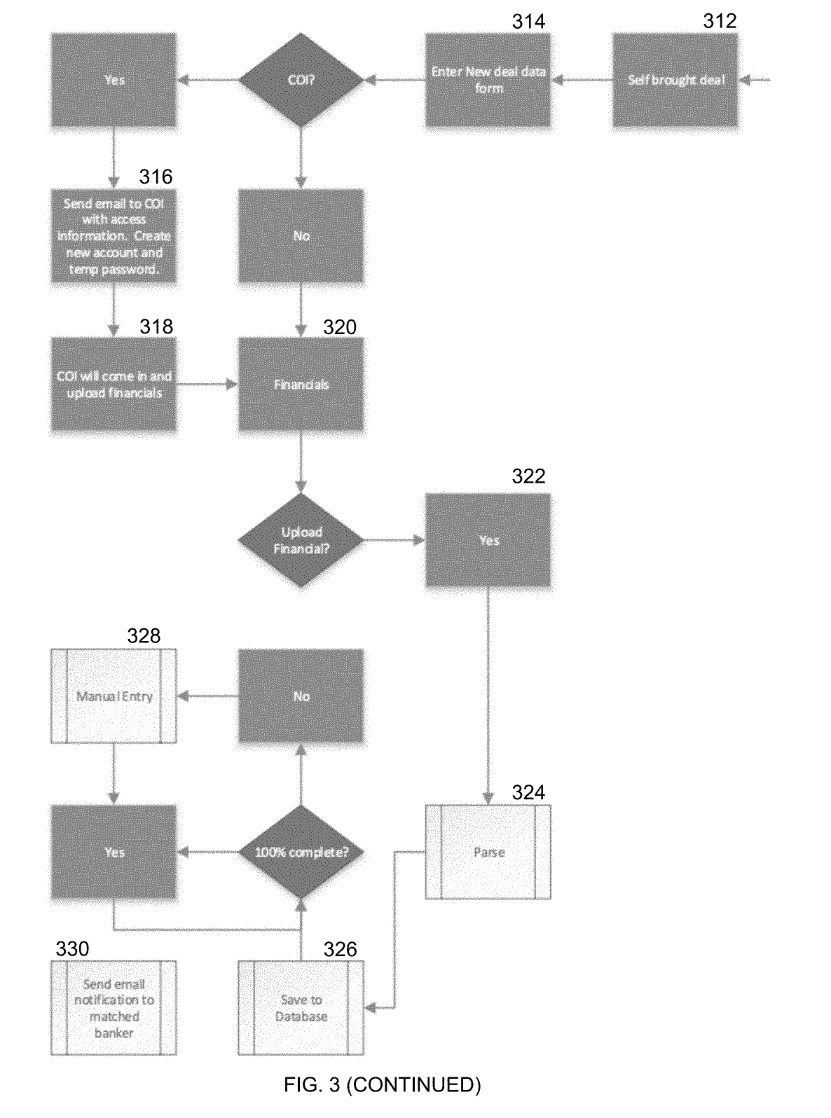

FIG. 3 illustrates a flowchart of an alternative method 300 for matching a lender and a borrower from the view of a lender dashboard. In one embodiment, an initial Step 302 may include providing a lender dashboard for a lender to operate the method 300. A Step 304 comprises matching loans on the network with special loan packages. A Step 306 comprises selecting toggle preferences to select data points 124. The matching algorithm 112a matches and ranks data points 124 from the loan related data 110. A Step 308 includes viewing the interview schedule. Another option after the lender dashboard Step 302 may include performing a Step 310 of viewing the loans in the pipeline, and view packages and interview scheduling.

Yet another option after the lender dashboard Step 302 may include performing a Step 312 of presenting, by the banker/lender 104a, 104b a self-brought deal. A Step 314 includes entering a new deal data form. If at this point there is COI, a Step 316 may include emailing and creating a new account and temporary password for company related professionals, i.e. COI (CPA, accountants, financial advisors, lawyers, and trusted advisors). A Step 318 may include uploading new financial data in the network 102. If no COI, then a Step 320 provides the financials immediately without needing to create a new account and password.

In some embodiments, a Step 322 involves uploading the financials for storage and future access. A Step 324 may include parsing the financials to provide a more refined picture of the borrower. A Step 326 comprises saving the parsed financials to a database. If more information is required, a Step 328 comprises manually entering in data points and personal information of the potential borrower. After determining that the evaluation is fully complete, a Step 330 may include sending an email or other type of notification to the potentially matched lender.

If there is a match between lender and borrower, a Step 332 may then include having an interview, or meeting to discuss the loan. If both parties cannot accept the proposed time for the interview, a Step 334 includes proposing a new time and working with a dashboard to set that up. The system 100 reschedules the interview with the interactive calendar, as shown in FIG. 1, to prepare a new time or date to meet. If the time is agreeable, Step 332 also includes interviewing the borrower in an online meeting, as shown in FIG. 1. In Step 336, a term sheet may be presented at this meeting. A final Step 338 then comprises providing the loan to the borrower.

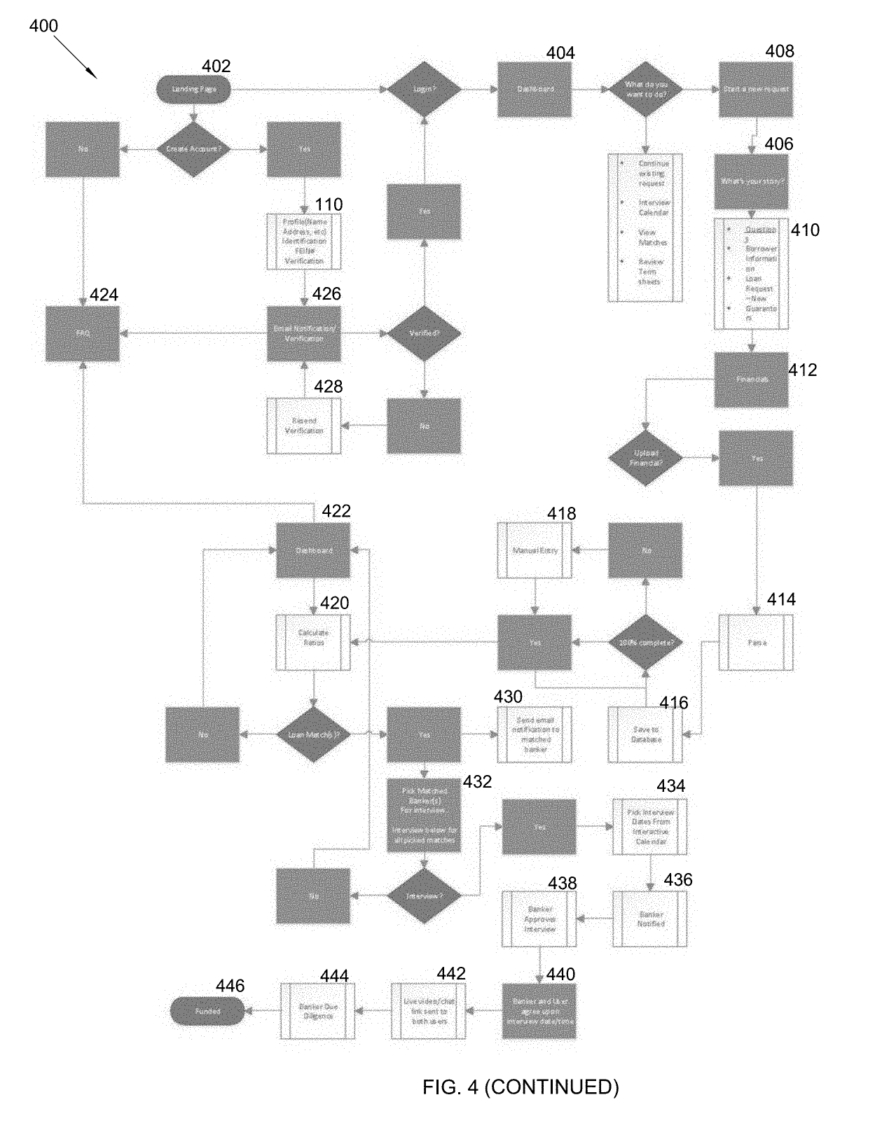

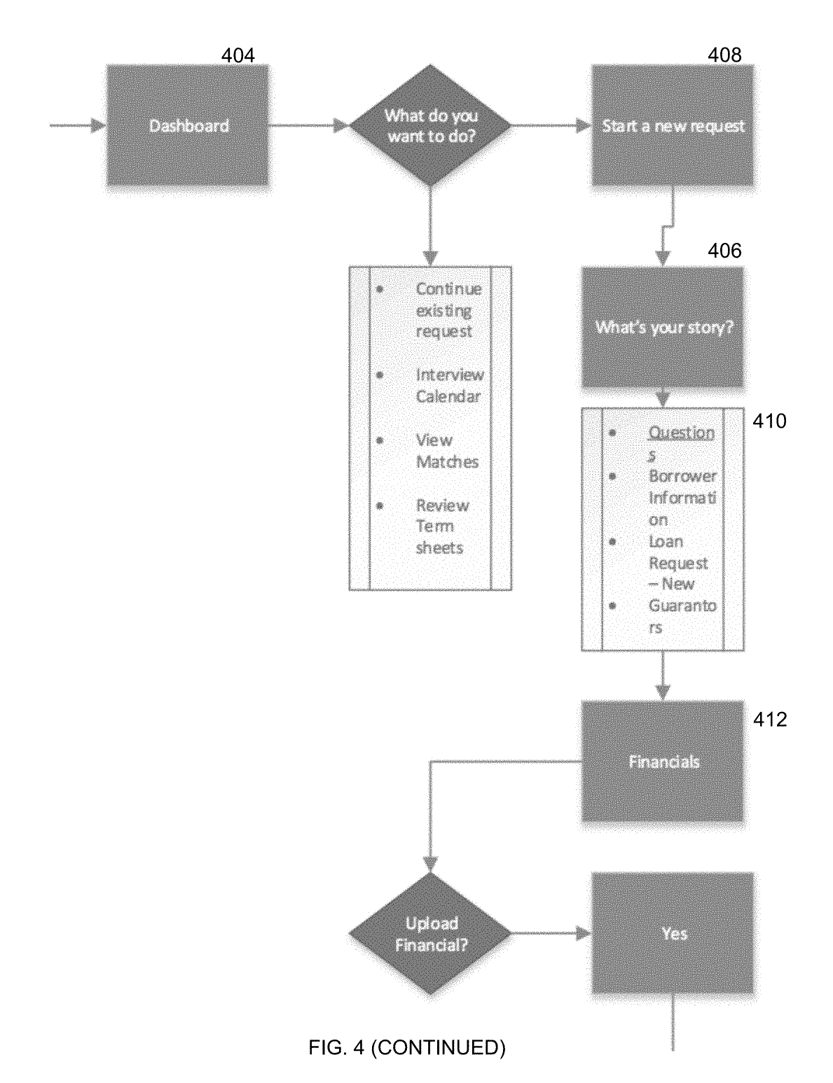

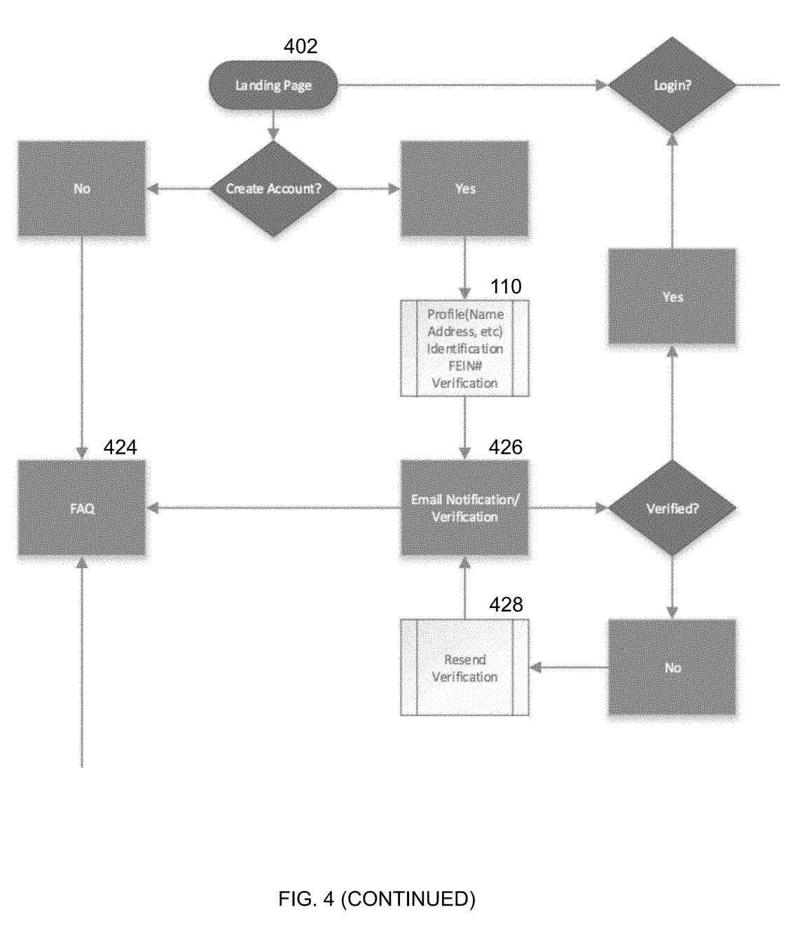

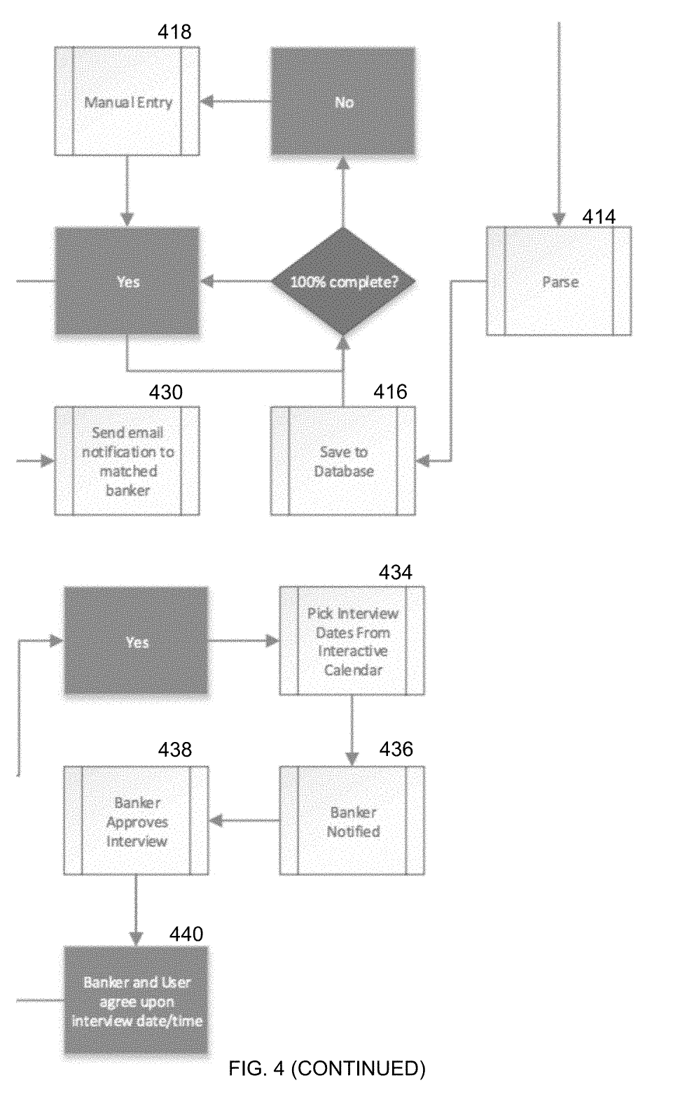

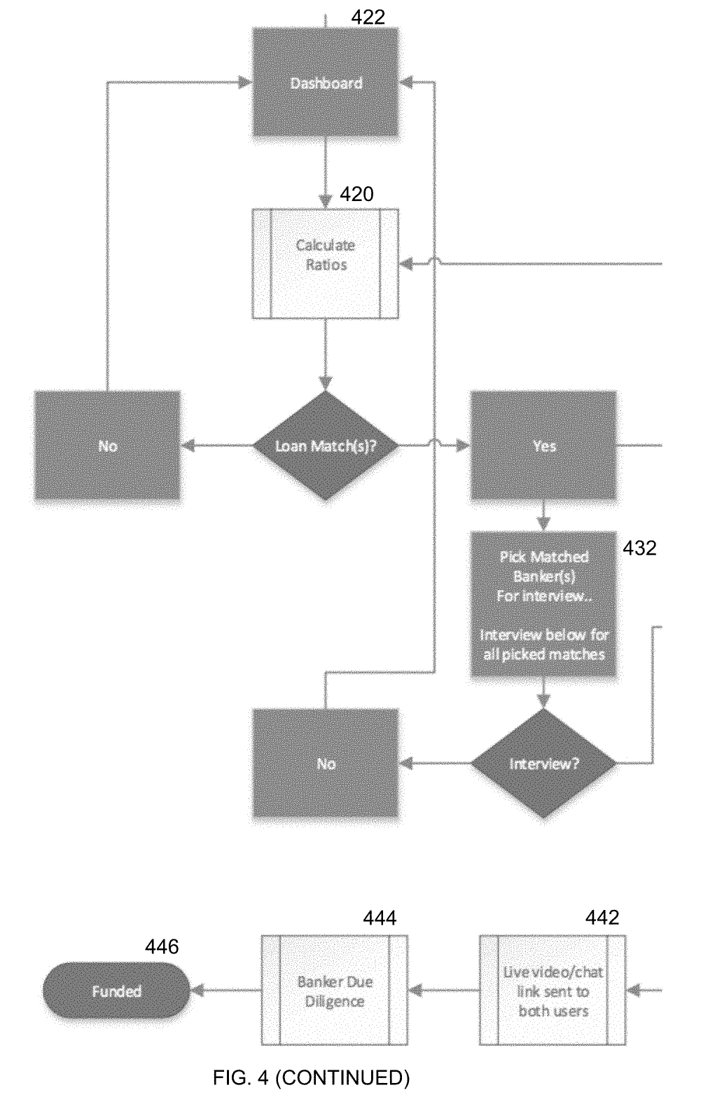

FIG. 4 illustrates a flowchart of an alternative method 400 for matching a lender and a borrower and application of data points to generate a color-coded financial ratio. In one embodiment, an initial Step 402 comprises providing a landing page on the network 102 for the borrower 106 or the lender 104a, 104b to view and operate the method 400. If logging in, a Step 404 comprises displaying a dashboard that displays pertinent information for the loan.

The dashboard may include a web page which collates information about the loan procedure and loan data 110. If a new loan request in needed, a Step 406 includes inquiring about the lender's story and financials. Another Step 408 may include starting a new loan request. A Step 410 comprises of asking borrowers specific questions about the loan, borrower business info, type of loan request, and guarantors. A Step 412 includes reviewing the financials of the borrower, while a Step 414 includes parsing the financials to create a more refined picture of the borrower. The information is then saved to a database in a Step 416. If more information is required, a Step 418 may include manually entering the financials and personal information of the borrower.

If the financials and information is fully complete, the data points are processed to calculate ratios, as shown in Step 420. A Step 422 allows this to occur on a lender dashboard. In some embodiment, a Step 424 occurs after creating an account, when the borrower proceeds to a Frequently Asked Questions (FAQ) page. A Step 426 comprises notifying the lender by email of a potential matching borrower, based on the financials. If the lender does not indicate receiving the notification, a Step 428 includes resending the verification if have not heard back from lender.

In some embodiment, a Step 430 may include determining if there is a loan match and then notifying the matched lender. A Step 432 includes the borrower, selecting the desired lender. If the lender agrees, a Step 434 includes, the borrower, selecting the desired time and date. A Step 436 comprises creating an interview time and date with the interactive calendar 118. A Step 438 may include notifying the lender that the borrower is interested in an interview and the lender approving of the time and date. A Step 440 comprises the lender and the borrower agreeing on the interview time and date. A Step 442 comprises a live interview on an Internet operable image capturing device 122. A Step 444 comprises the lender performing due diligence to determine of the borrower can receive the loan. A final Step 446 comprises funding the loan to the borrower.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. One or more computer storage media storing computer-usable instructions, that when used by one or more computing devices, cause the one or more computing devices to perform a method for matching a lender and a borrower based on color-coded financial ratios, and discussing the loan through an online meeting, comprising the steps of:
providing a network accessible by at least one lender and a borrower, whereby the at least one lender and the borrower interact on the network;
submitting, by the borrower, a loan related data onto the network, the loan related data configured into at least one format;
processing the loan related data with an algorithm;
answering, through analysis by the algorithm, at least one question from the borrower;
generating, through analysis by the algorithm, a color-coded financial ratio based on the loan related data;
initially approving the borrower by the at least one lender based on the color-coded financial ratio;
accepting, by the borrower, the potential lender;
setting up a meeting, through an interactive calendar, between the at least one lender and the initially approved borrower; and
performing the online meeting with an Internet operable image capturing device between the at least one lender and the initially approved borrower.

2. The method of claim 1, wherein the network includes at least one of the following: a website, an Internet, an Intranet, and a social media site.

3. The method of claim 1, wherein the at least one lender includes at least one of the following: a bank, a lending agent, a private lender, and crowd sourcing.

4. The method of claim 1, wherein the borrower includes at least one of the following: a consumer, a corporation, and a government.

5. The method of claim 1, wherein the loan related data includes at least one of the following: name, personal information, job information, contact information, social security number, bank account, financial information, EIN#, business plan, and the purpose for the loan request.

6. The method of claim 1, wherein the algorithm includes at least one of the following: a matching algorithm, a financial algorithm, and a query algorithm.

7. The method of claim 6, wherein the matching algorithm is configured to match and rank data points from the loan related data, the matching algorithm is also configured to weigh averages and generate graphs from the data points.

8. The method of claim 7, wherein the query algorithm is configured to learn.

9. The method of claim 1, wherein the method further comprises a step of storing the loan related data in a database.

10. The method of claim 9, wherein the method further comprises a step of retrieving, by the algorithm or the at least one lender, the loan related data from the database.

11. The method of claim 1, wherein the color-coded financial ratio comprises multiple loan industry standard metrics categorized into multiple colors.

12. The method of claim 1, wherein the interactive calendar is viewable and manipulated by both the at least one lender and the borrower.

13. The method of claim 1, wherein the Internet operable image capturing device comprises a webcam.

14. The method of claim 1, wherein the step of answering, through analysis by the algorithm, at least one question from the borrower, further comprises a chatbot configured to interact with the borrower.

15. The method of claim 14, wherein the chatbot includes at least one of the following: a talkbot, a Bot, a chatterbox, an artificial conversational entity, and a computer program which conducts a conversation via auditory or textual methods.

16. A non-transitory program storage device readable by a machine tangibly embodying a program of instructions executable by the machine to perform a method for matching a lender and a borrower based on color-coded financial ratios, and discussing the loan through an online meeting, the method consisting of:
computer code for providing a network accessible by at least one lender and a borrower, whereby the at least one lender and the borrower interact on the network;
computer code for submitting, by the borrower, a loan related data onto the network, the loan related data configured into at least one format;
computer code for processing the loan related data with an algorithm, the algorithm including at least one of the following: a matching algorithm, a financial algorithm, and a query algorithm;
computer code for storing the loan related data in a database;
computer code for retrieving, by the algorithm or the at least one lender, the loan related data from the database.
computer code for answering, through analysis by the algorithm, at least one question from the borrower with a chatbot;
computer code for generating, through analysis by the algorithm, a color-coded financial ratio based on the loan related data;
computer code for initially approving the borrower by the at least one lender based on the color-coded financial ratio;
computer code for accepting, by the borrower, the potential lender;
computer code for setting up a meeting, through an interactive calendar, between the at least one lender and the initially approved borrower; and
computer code for performing the online meeting with an Internet operable image capturing device between the at least one lender and the initially approved borrower.

17. The method of claim 16, wherein the color-coded financial ratio comprises multiple loan industry standard metrics categorized into multiple colors.

18. The method of claim 16, wherein the interactive calendar is viewable and manipulated by both the at least one lender and the borrower.

19. The method of claim 16, wherein the Internet operable image capturing device is a webcam.

20. A system for matching a lender and a borrower based on color-coded financial ratios, and discussing the loan through an online meeting, the system comprising:
a network configured to be accessible by a borrower and at least one lender, whereby the borrower and the at least one lender transact a loan substantially through the network;
a loan related data submittal to the network by the borrower;
a database configured to store the loan related data;
an algorithm configured to process the loan related data, the algorithm including at least one of the following: a matching algorithm, a financial algorithm, and a query algorithm;
a color-coded financial ration configured to represent analysis of the financial data, whereby the at least one lender reviews the color-coded financial ratio;
a chatbot configured to answer a query by the borrower;
an interactive calendar configured to enable the borrower and the at least one lender to set up an online meeting; and
an Internet operable image capturing device configured to enable the online meeting between the borrower and the at least one lender, so as to discuss the loan.
